(19) United States
(12) Patent Application Publication
(10) Pub. No.: US 2026/0252775 A1
(43) Pub. Date: Aug. 27, 2026

(54) METHOD AND COMPUTING SYSTEM FOR DESIGNING INTEGRATED CIRCUIT

(71) Applicant: SAMSUNG ELECTRONICS CO., LTD., Suwon-si (KR)

(72) Inventor: Kiwon YOON, Suwon-si (KR)

(73) Assignee: SAMSUNG ELECTRONICS CO., LTD., Suwon-si (KR)

(21) Appl. No.: 19/536,747

(22) Filed: Feb. 11, 2026

(30) Foreign Application Priority Data
Feb. 21, 2025 (KR) 10-2025-0023166
Aug. 1, 2025 (KR) 10-2025-0106121

(51) Int. Cl. G06F 30/39; G06F 30/392; G06F 30/398

(52) U.S. Cl. CPC G06F 30/39; G06F 30/392; G06F 30/398

(57) ABSTRACT

A method, performed by a computing system, of designing an integrated circuit includes extracting first process information, first floorplan information, and first power plan information from a power plan of a first process, extracting second process information and second floorplan information from a floorplan of a second process, recognizing a regular wiring pattern of a power line from the power plan of the first process based on the first power plan information, forming a new wiring pattern of the power line according to the second process information and the second floorplan information, and generating second power plan information including the new wiring pattern.

### CROSS-REFERENCE TO RELATED APPLICATIONS

This application is based on and claims priority under 35 U.S.C. §119 to Korean Patent Application Nos. 10-2025-0023166, filed on Feb. 21, 2025, and 10-2025-0106121, filed on Aug. 1, 2025, in the Korean Intellectual Property Office, the disclosures of which are incorporated by reference herein in their entireties.

### BACKGROUND

The present disclosure relates to a method and a computing system for designing an integrated circuit, and more particularly, to a method and a computing system for designing an integrated circuit, capable of generating power plan of a new process by using the power plan of an initial process.

When an integrated circuit is designed, some digital circuits in the integrated circuit are redesigned while maintaining the functions thereof and changing only a process. To redesign, in a new process, a digital circuit of which the design is completed in an initial process, a design process needs to be performed again from the first stage, and a design rule fit to the new process needs to be applied to each design process.

### SUMMARY

The disclosure provides a method and a computing system for designing an integrated circuit, capable of generating a power plan of a new process by using the power plan of an initial process.

According to an aspect of an embodiment, a method, performed by a computing system, of designing an integrated circuit, includes: extracting first process information, first floorplan information, and first power plan information from a power plan of a first process; extracting second process information and second floorplan information from a floorplan of a second process; recognizing a regular wiring pattern of a power line from the power plan of the first process based on the first power plan information; forming a new wiring pattern of the power line according to the second process information and the second floorplan information; and generating second power plan information including the new wiring pattern.

According to another aspect of an embodiment, a method, performed by a computing system, of designing an integrated circuit, includes: dividing an initial floorplan into a plurality of areas based on initial floorplan information; recognizing a regular wiring pattern of a power line formed in a certain area among the plurality of areas based on initial power plan information; forming a new wiring pattern of the power line by changing, according to new process information and new floorplan information, the regular wiring pattern to satisfy a rule of a new process; and generating new power plan information including the new wiring pattern.

According to another aspect of an embodiment, a computing system includes: a memory in which instructions are stored; and a processor, wherein the instructions, when executed by the processor, are configured to control the computing system to: extract first process information, first floorplan information, and first power plan information from a power plan of a first process, extract second process information and second floorplan information from a floorplan of a second process, recognize a regular wiring pattern of a power line from the power plan of the first process based on the first power plan information, form a new wiring pattern of the power line according to the second process information and the second floorplan information, and generate second power plan information including the new wiring pattern.

### BRIEF DESCRIPTION OF DRAWINGS

The above and other objects and features will be more clearly understood from the following description of embodiments, taken in conjunction with the accompanying drawings, in which:

FIG. 1 is a flowchart illustrating a method of designing an integrated circuit, according to an embodiment;

FIG. 2 illustrates a power plan operation in a method of designing an integrated circuit, according to an embodiment;

FIG. 3 is a flowchart illustrating a method of designing an integrated circuit, according to an embodiment;

FIGS. 4 to 6 illustrate a method of designing an integrated circuit, according to an embodiment;

FIGS. 7 and 8 illustrate a method of designing an integrated circuit, according to an embodiment;

FIG. 9 illustrates a method of designing an integrated circuit, according to an embodiment;

FIG. 10 is a flowchart illustrating a method of designing an integrated circuit, according to an embodiment;

FIG. 11 is a flowchart illustrating a method of designing an integrated circuit, according to an embodiment;

FIG. 12 illustrates a method of designing an integrated circuit, according to an embodiment;

FIG. 13 illustrates a method of designing an integrated circuit, according to an embodiment;

FIG. 14 is a block diagram illustrating a computing system including a memory storing a program for an integrated circuit design, according to an embodiment; and

FIG. 15 is a block diagram illustrating instructions stored in a memory, according to an embodiment.

### DETAILED DESCRIPTION

Hereinafter, embodiments are described in detail with reference to the accompanying drawings. Each embodiment provided in the following description is not excluded from being associated with one or more features of another example or another embodiment also provided herein or not provided herein but consistent with the present disclosure.

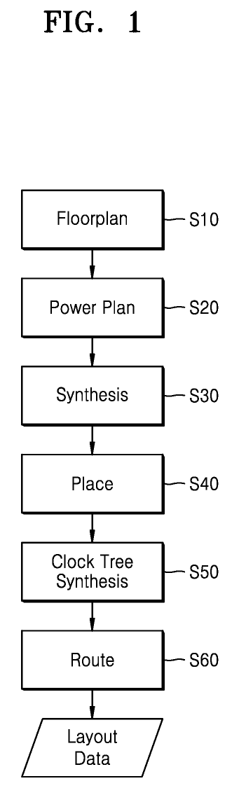

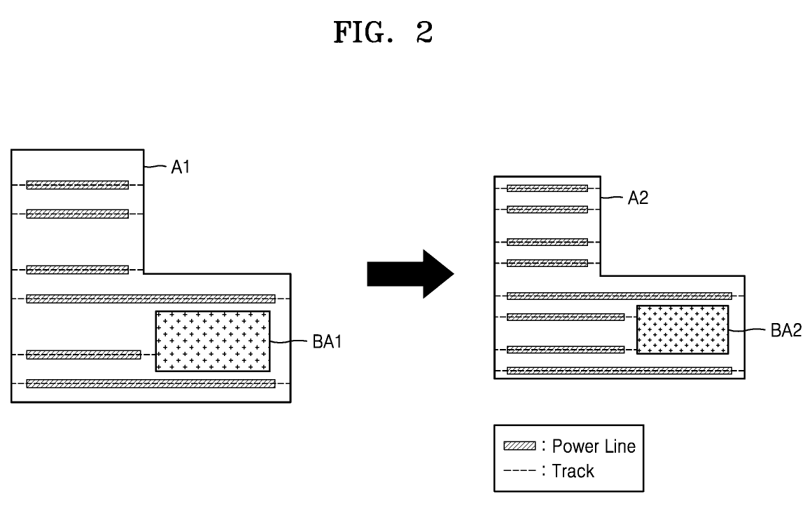

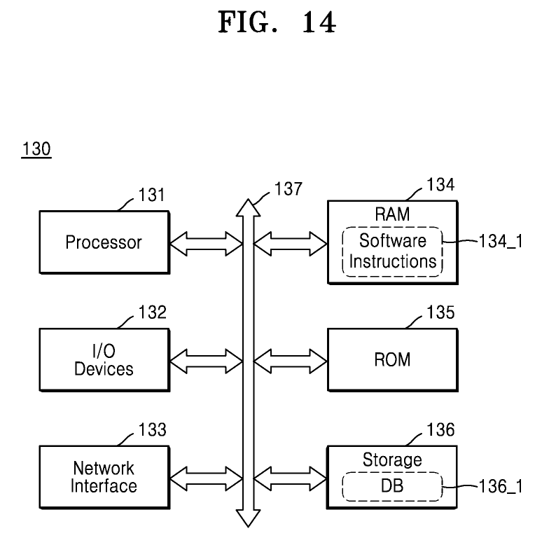

FIG. 1 is a flowchart illustrating a method of designing an integrated circuit (IC), according to an embodiment. FIG. 2 illustrates a power plan operation in a method of designing an IC, according to an embodiment. The method of designing an IC, which is described with reference to FIG. 1 and the like, is designing the layout of the IC and may be performed by a computing system (e.g., computing system 130 of FIG. 14) for designing an IC. The computing system 130 may include a storage device storing a plurality of instructions to be executed by a processor. Accordingly, the present designing process may be a computer implemented operation for designing an IC. A process of manufacturing a semiconductor device based on the designed layout may be performed by a semiconductor process module.

Referring to FIG. 1, the method of designing an IC may be performed by receiving information (e.g., process information, node information of a block, tool information for the design, and the like) for designing the IC and may include a floorplan operation S10, a power plan operation S20, a synthesis operation S30, a place operation S40, a clock tree synthesis (CTS) operation S50, and a route operation S60.

The floorplan operation S10 may be an operation of physically designing a logically designed schematic circuit through cut and movement. For example, a floorplan may indicate placement of each of blocks included in the IC and indicate schematic placement of gates in each block. A block included in the IC is referred to a function block. The functional block may be a unit of a layout that is independently designed and formed, and may include a plurality of cells. In an embodiment, a plurality of function blocks comprise a memory function block and/or a circuit function block. In the floorplan operation S10, a plurality of memory function blocks and/or a plurality of circuit function blocks may be placed. In the floorplan operation S10, for example, the plurality of circuit function blocks supposed to be placed adjacently to each other may be identified, and a space for the plurality of circuit function blocks may be allocated by considering a usable space, a necessary function, and the like. In addition, in the floorplan operation S10, for example, size information (e.g., horizontal and vertical lengths) of a space for a circuit function block may be determined, and the positions of input/output ports placed in the circuit function block, the size and position of a macro cell placed in the circuit function block, the size position of a blockage area in the circuit function block, and the like may be determined. The blockage area may indicate an area for which the placement of a power line (or a power via) is not determined in the power plan operation S20.

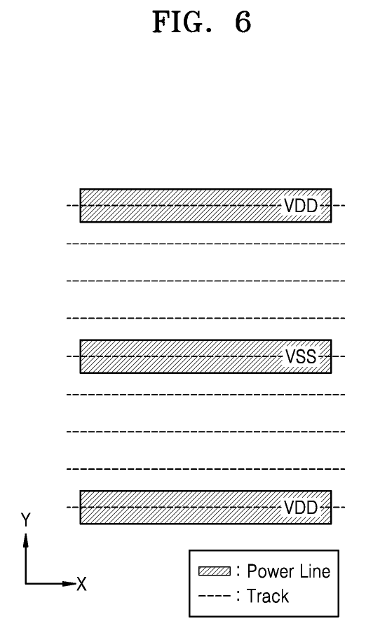

The power plan operation S20 may be an operation of placing patterns of wirings for connecting local power, e.g., a power supply voltage (e.g., VDD of FIG. 6) or a ground voltage (e.g., VSS of FIG. 6), to the plurality of circuit function blocks placed in the IC. For example, wiring patterns of a power line connecting the power supply voltage or the ground voltage such that power is well supplied in a net form to a circuit function block and the entire IC (or chip) may be generated. In the power plan operation S20, the wiring patterns may be generated in a net form through various rules.

In the synthesis operation S30, netlist data may be generated from register-transfer level (RTL) data. For example, a semiconductor design tool (e.g., a synthesis module) may generate netlist data including a bitstream or a netlist from RTL data, which is created using a very high-speed integrated circuit (VHSIC) hardware description language (HDL) (VHDL) or an HDL, such as Verilog, by performing synthesis with reference to a standard cell library. The standard cell library may include data defining a structure of standard cells configured to perform the same function and having different layouts, and standard cells may be included in the IC with reference to the standard cell library in a synthesis process.

The place operation S40 is an operation of placing patterns of devices constituting the circuit function block and may include placing standard cells from the standard cell library. Empty areas may occur (e.g., be present) between the standard cells, and filler cells may be placed in the empty areas. Unlike the standard cells, the filler cells may include a dummy area. For example, a filler cell may correspond to a region that does not include circuit components configured to implement functional logic of the integrated circuit, and may include non-functional structures that are electrically grounded or electrically floating. Such non-functional structures may be formed of, for example, fill materials, including metal layers and polysilicon.

By the place operation S40, the shape and size of a pattern for configuring transistors and wirings to be actually formed on a silicon substrate may be defined. For example, to actually form an inverter circuit on the silicon substrate, layout patterns, such as a P-channel metal-oxide-semiconductor (PMOS) transistor, an N-channel metal-oxide-semiconductor (NMOS) transistor, an N-well, a gate electrode, and wirings to be placed thereon, may be properly placed. In an embodiment, even after the place operation S40, the CTS operation S50, or the route operation S60 to be described below are performed, the place operation S40 may be performed again according to a verification result.

The CTS operation S50 may be an operation of generating patterns of signal lines of a central clock related to an operating speed for determining the performance of a semiconductor device.

The route operation S60 may be an operation of generating a wiring structure connecting the standard cells placed as described above. The wiring structure may be electrically connected to wirings inside the standard cells to electrically connect the standard cells to each other, wherein the input pins or output pins of the standard cells are connected to each other.

Thereafter, a result of the place, CTS, and route operations S40 to S60 may be verified. For example, a timing engineering change order (ECO) operation may be further performed, and predetermined physical design rule check (DRC) and correction may be performed.

In an embodiment, the timing ECO operation may include a static timing analysis (STA) operation and an update timing operation. For example, the timing ECO operation may include a timing optimization operation, and for verification, an operation of determining whether there is a timing violation may be included. For example, it may be determined where there is a flip-flop setup time violation or hold time violation.

When operations S10 to S60 of designing the IC, which have been described above, are completed, layout data may be generated, and then, an optical proximity correction (OPC) operation, a mask manufacturing operation, and an IC fabricating operation may be performed based on the layout data. OPC may indicate a task for forming a pattern of a desired shape by correcting a distortion phenomenon, such as refraction, caused by the characteristic of light in photolithography included in a semiconductor process for fabricating an IC. In the mask manufacturing operation, patterns on a mask may be defined to form patterns formed on a plurality of layers, and at least one mask (or photomask) for forming respective patterns of the plurality of layers may be manufactured. In the IC fabricating operation, an IC may be fabricated using the manufactured at least one mask to pattern the plurality of layers, and the IC fabricating operation may include a front-end-of-line (FEOL) process, a middle-of-line (MOL) process, and a back-end-of-line (BEOL) process.

Referring to FIGS. 1 and 2, a second power plan of a new second process may be designed from a first power plan of a first process of which the design is completed. Information representing power lines (or power vias) placed in a first floorplan A1 of a certain digital circuit designed according to the first process may be defined as the first power plan. In a second floorplan A2 of the second process, which corresponds to the first floorplan A1 of the first process, while the same digital circuit (i.e., the same logical function but distinct physical layout) is formed, according to a changed process, the size of a circuit function block, the positions of input/output ports placed in the circuit function block, the size and position of a macro cell placed in the circuit function block, the size and position of a second blockage area BA2 in the circuit function block, and the like may vary. For example, the size of the second blockage area BA2 in the second floorplan A2 may be smaller than the size of a first blockage area BA1 in the second floorplan A1. In the power plan operation S20 for designing a second power plan of the second process, the width of a power line placed in a track defined in the second floorplan A2, the pitch between power lines, an offset of the power line, a layer on which the power line is placed, and the like may be determined using the first power plan of the first process that is an initial process. For example, the initial process may be a process that has been designed and is to be updated.

That is, in an embodiment, in the power plan operation S20, the power plan of the new process may be generated using the power plan of the initial process. For example, in the power plan operation S20, the power plan of the new process may be generated from the power plan of the initial process and the floorplan of the new process. Therefore, compared to redesigning from the first beginning by a designer, a digital circuit of which the design has been completed in a certain process may be redesigned in another process through automation while maintaining the function and design characteristics of the digital circuit, and the time taken to design a power plan may be reduced.

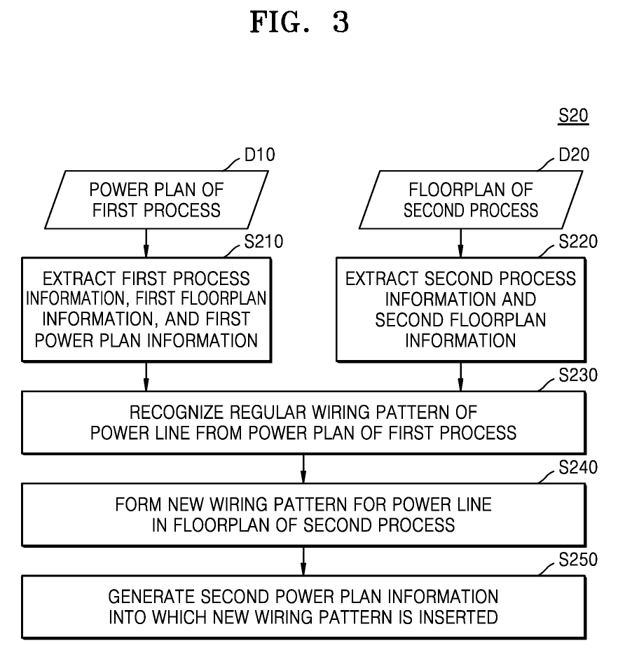

FIG. 3 is a flowchart illustrating a method of designing an IC, according to an embodiment, and more particularly, a flowchart illustrating a power plan operation.

Referring to FIG. 3, the power plan operation S20 may include operations S210 to S250. In the power plan operation S20, a power plan D10 of a first process and a power plan D20 of a second process may be received. Herein, the first process may indicate an initial process with a completed design, and the second process may indicate a new process of designing an IC, which has been described with reference to FIG. 1.

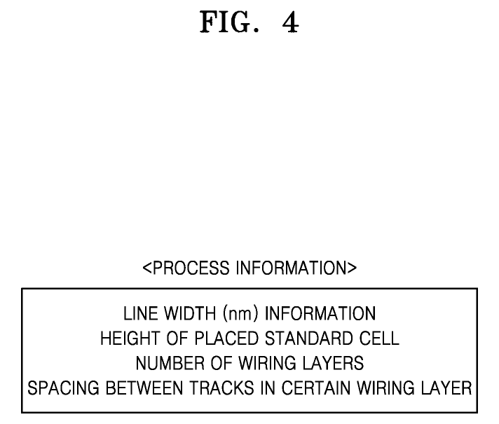

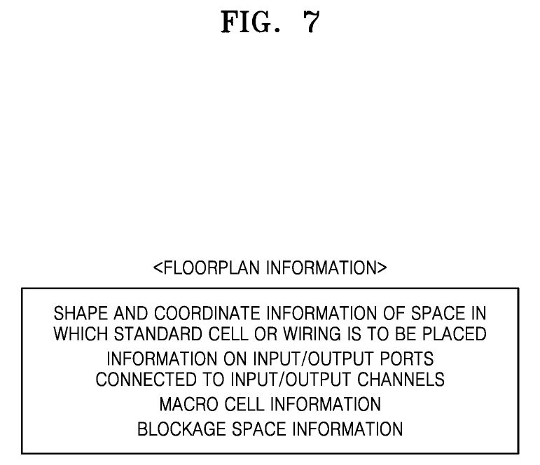

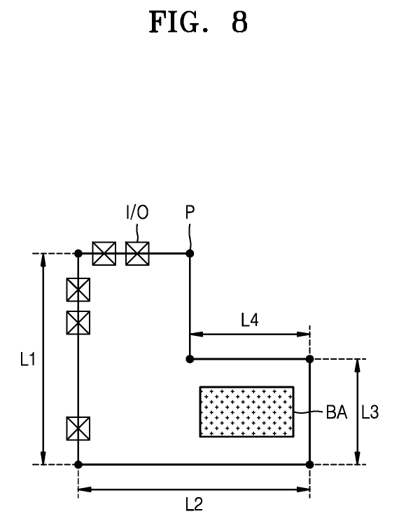

In operation S210, first process information, first floorplan information, and first power plan information may be extracted from the power plan D10 of the first process. In operation S220, second process information and second floorplan information may be extracted from the power plan D20 of the second process. The first process information and the second process information will be particularly described below with reference to FIG. 4, the first floorplan information and the second floorplan information will be particularly described below with reference to FIG. 7, and the first power plan information and second power plan information will be particularly described below with reference to FIG. 8. The pieces of information extracted in operations S210 and S220 may be stored in a database (e.g., 136_1 of FIG. 14) of a computing system (e.g., 130 of FIG. 14).

In operation S230, a regular wiring pattern of a power line in the power plan D10 of the first process may be recognized based on the first power plan information. For example, a bundle in which a regular wiring pattern of a first power line or a second power line is repeated may be recognized, the number of first power lines, the width of the first power line, and the pitch between the first power lines in the bundle may be recognized, and the number of second power lines, the width of the second power line, and the pitch between the second power lines in the bundle may be recognized. For example, the first power line may indicate a power line to which a power supply voltage VDD is applied, and the second power line may indicate a power line to which a ground voltage VSS is applied.

In operation S240, a new wiring pattern for the power line may be formed in the floorplan of the second process according to the second process information and the second floorplan information. For example, in operation S240, the regular wiring pattern recognized in operation S230 may be changed to satisfy a rule of the second process, based on the rule of the second process included in the second process information, thereby forming a new wiring pattern in the floorplan of the second process. In an embodiment, the rule of the second process may include at least one of values which the minimum pitch between bundles in which a regular wiring pattern is repeated, the minimum length of a power line, and the width of the power line may have.

In operation S250, second power plan information into which the new wiring pattern of the power line is inserted may be generated. The second power plan information representing the new wiring pattern may be output as a power plan script.

FIGS. 4 to 6 illustrate a method of designing an IC, according to an embodiment, and more particularly, illustrate process information used in a power plan operation.

Referring to FIG. 4, first process information extracted from the power plan (e.g., D10 of FIG. 3) of a first process and second process information extracted from the floorplan (e.g., D20 of FIG. 3) of a second process may include line width information representing dimensions in nanometers (nm). The line width information may include information representing the line width of a circuit or information representing the length of a channel of a transistor. The line width information is a name referred to as a corresponding process, and a smaller number may indicate a more advanced front-end process.

The first process information and the second process information may include information representing the height of a standard block placed in a circuit function block and may also include at least one of the number of wiring layers formed in the circuit function block and the spacing between tracks in a certain wiring layer.

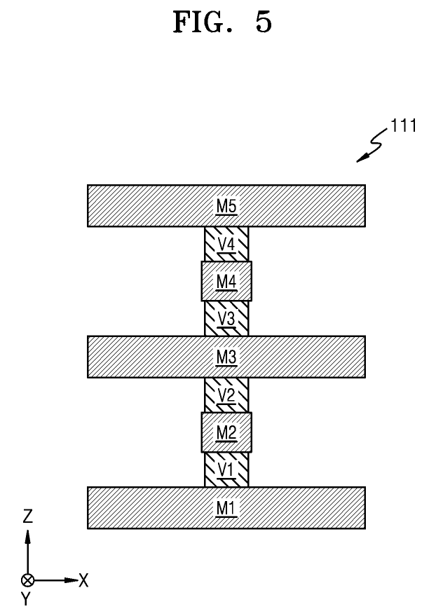

Referring to FIG. 5, a wiring structure formed in a circuit function block may include a plurality of wiring layers, e.g., first to fifth wiring layers M1 to M5, and a plurality of via layers, e.g., first to fourth via layers V1 to V4, stacked in the vertical direction (e.g., the Z-axis direction). The number of wiring layers shown in FIG. 5 is one example, and the number of wiring layers formed according to a circuit function block may be variously changed. A wiring layer in which a power line is placed may be determined based on information representing the number of wiring layers formed in the circuit function block, which is included in the first process information and the second process information.

The first to fourth via layers V1 to V4 may electrically connect the first to fifth wiring layers M1 to M5 located on different layers. For example, the first via layer V1 may be placed between the first wiring layer M1 and the second wiring layer M2 and include a via pattern to electrically connect the first wiring layer M1 to the second wiring layer M2.

In an embodiment, a direction in which a pattern extends may be designated in each of the first to fifth wiring layers M1 to M5. For example, a pattern extending in a first horizontal direction (e.g., the X-axis direction) may be formed on the first wiring layer M1, and a pattern extending in a second horizontal direction (e.g., the Y-axis direction) may be formed on the second wiring layer M2. For example, a pattern extending in the first horizontal direction may be formed on the first, third, and fifth wiring layers M1, M3, and M5 that are odd numbered layers, and a pattern extending in the second horizontal direction may be formed on the second and fourth wiring layers M2 and M4 that are even-numbered layers.

Referring to FIG. 6, in each of a plurality of wiring layers, an area in which a pattern is formed may be defined as a track. For example, a pattern extending in the first horizontal direction may be formed on a first wiring layer. On defined tracks, a first power line for providing the power supply voltage VDD and a second power line for providing the ground voltage VSS may be selectively placed, and wirings for transmitting a signal between circuits constituting a circuit function block may be selectively placed. Alternatively, a third power line for providing a power supply voltage having a voltage level different from that of the power supply voltage VDD may be further placed. Although FIG. 6 illustrates the first wiring layer, tracks may be similarly defined on other wiring layers. The width of a power line, the pitch of power lines, an offset of the power line, and the like may be determined from spacing information between tracks in a wiring layer, which is included in the first process information and the second process information.

In an embodiment, it may be defined such that the spacing between tracks, which is defined in a certain layer, is constant. However, the disclosure is not limited thereto, and it may be designed such that the spacing between tracks varies depending on areas even in the certain layer.

FIGS. 7 and 8 illustrate a method of designing an IC, according to an embodiment, and more particularly, illustrate floorplan information used in a power plan operation.

Referring to FIGS. 7 and 8, first floorplan information extracted from the power plan (e.g., D10 of FIG. 3) of a first process and second floorplan information extracted from the floorplan (e.g., D20 of FIG. 3) of a second process may include shape and coordinate information representing a space of a circuit function block. For example, the first floorplan information and the second floorplan information may include the coordinates of each apex P of the space in which the circuit function block is formed, lengths (e.g., L1 to L4) defining the space in which the circuit function block is formed, or the like.

The first floorplan information and the second floorplan information may include information representing input/output ports I/O connected to input/output channels. The information on the input/output ports I/O may include position coordinate (i.e., location) information of the input/output ports I/O and information representing the input/output channels connected to the input/output ports I/O.

The first floorplan information and the second floorplan information may include information representing a macro cell placed in the circuit function block. The information representing the macro cell may include information indicating the type of the macro cell, the position at which the macro cell is placed, and the size of the macro cell. For example, a static random access memory (SRAM) cell may be placed in the circuit function block, and the information about the macro cell may include information representing the position at which the SRAM cell is placed and the size of the SRAM cell.

The first floorplan information and the second floorplan information may include blockage space information. A blockage space BA may indicate a space in which no standard cell is placed or a space in which no wiring for routing is formed (i.e., a space in which a pre-designated wiring pattern is formed). In an embodiment, the macro cell may be placed in the blockage space BA.

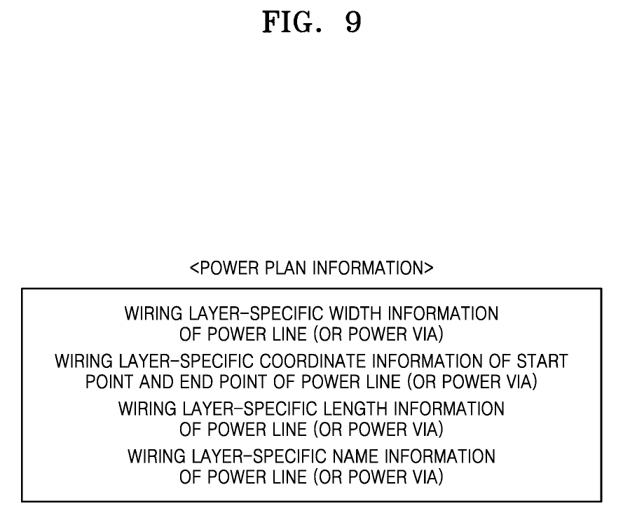

FIG. 9 illustrates a method of designing an IC, according to an embodiment, and more particularly, illustrates power plan information used or generated in a power plan operation.

Referring to FIG. 9, first power plan information extracted from the power plan (e.g., D10 of FIG. 3) of a first process and second power plan information generated in the power plan operation (e.g., S20 of FIG. 3) may include layer (e.g., wiring layer or via layer)-specific width information representing a power line (or a power via). For example, the power line may be formed on each of the first to fifth wiring layers M1 to M5 described with reference to FIG. 5, and the first power plan information and the second power plan information may include information representing the width of a power line in each of the first to fifth wiring layers M1 to M5 and information representing the width of a power via in each of the first to fourth via layers V1 to V4.

The first power plan information and the second power plan information may include coordinate information representing a wiring layer (or via layer)-specific start point and end point of the power line (or power via) or wiring layer (or via layer)-specific length information representing the power line (or power via).

In addition, the first power plan information and the second power plan information may include wiring layer (or via layer)-specific name information representing the power line (or power via). The name information representing the power line (or power via) may be determined according to a voltage provided by the power line (or power via). For example, a power line (or power via) through which the power supply voltage VDD is provided may be referred to as “VDD”, and a power line (or power via) through which the ground voltage VSS is provided may be referred to as “VSS”.

Alternatively, a power line (or power via) through which a power supply voltage other than the power supply voltage VDD is provided may be further formed, and the first power plan information or the second power plan information may include information about the power line (or power via) through which the power supply voltage other than the power supply voltage VDD is provided.

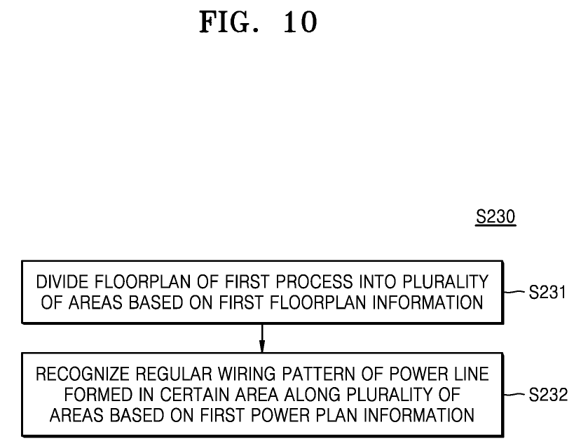

FIG. 10 is a flowchart illustrating a method of designing an IC, according to an embodiment, and more particularly, a flowchart illustrating an example of operation S230 of FIG. 3.

Referring to FIG. 10, operation S230 may include operations S231 and S232.

In operation S231, the floorplan of a first process may be divided into a plurality of areas based on first floorplan information. In an embodiment, the floorplan may be divided into a power domain area in which a standard cell is placed in the floorplan and a macro cell area in which a macro cell is placed in the floorplan.

In operation S232, a regular wiring pattern of a power line formed in a certain area among the plurality of areas may be recognized based on the first power plan information. For example, a regular wiring pattern of a power line formed in the power domain area among the plurality of areas may be recognized. A macro cell area of a circuit function block may be classified into a blockage area in which no standard cell is placed. In the blockage area, according the characteristics of a macro cell, pre-designated device and wiring patterns may be formed, and pre-designated power lines may be displaced. Therefore, to generate second power plan information of a second process, information from the first power plan information representing a power line formed in the power domain area may be necessary.

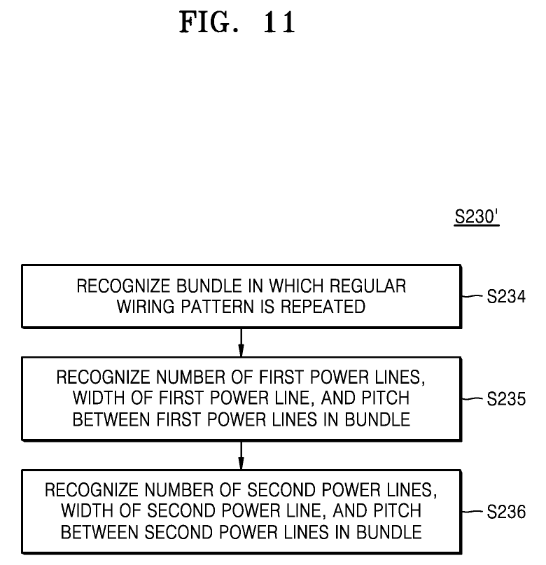

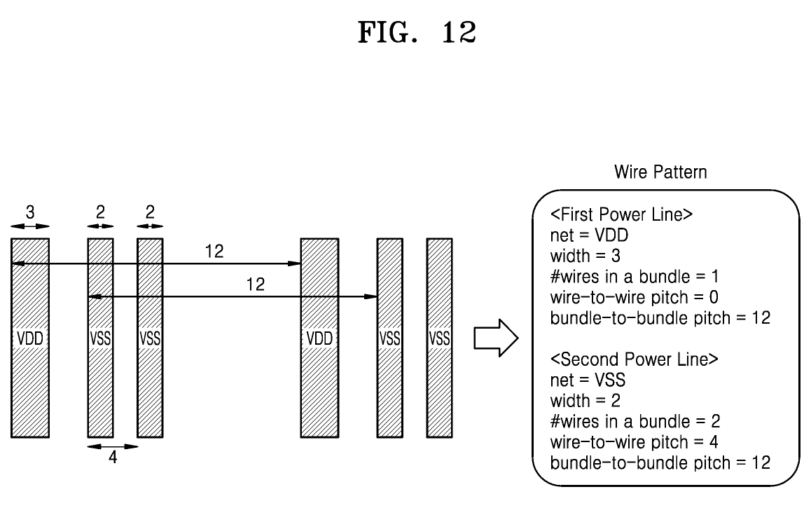

FIG. 11 is a flowchart illustrating a method of designing an IC, according to an embodiment, and more particularly, a flowchart illustrating an example of operation S230 of FIG. 3. FIG. 12 illustrates a method of designing an integrated circuit, according to an embodiment.

Referring to FIGS. 11 and 12, operation S230’ may include operations S234 to S236.

In operation S234, a bundle in which a regular wiring pattern is repeated may be recognized. The bundle may indicate a unit in which a regular wiring pattern is repeated. In operation S235, the number of first power lines, the width of the first power line, and the pitch (spacing) between the first power lines in the bundle may be recognized. In addition, in operation S236, the number of second power lines, the width of the second power line, and the pitch between the second power lines in the bundle may be recognized. In operation S230’, the pitch between bundles may be further recognized.

For example, the first power line recognized in operation S235 may be a power line to which the power supply voltage VDD is applied, wherein the width of the first power line is 3 nm, the number of first power lines in a bundle is 1, and accordingly, the pitch between first power lines in the bundle is 0. The pitch between bundles may be 12 nm.

In addition, for example, the second power line recognized in operation S236 may be a power line to which the ground voltage VSS is applied, wherein the width of the second power line is 2 nm, the number of second power lines in a bundle is 2, and the pitch between the second power lines in the bundle is 4 nm. The pitch between bundles may be 12 nm.

Although FIG. 12 illustrates the first power line to which the power supply voltage VDD is applied and the second power lines to which the ground voltage VSS is applied, the disclosure is not limited thereto, and information (the width of a power line, the number of power lines, and the pitch between the power lines) regarding a regular pattern of the power line (or power via) through which a power supply voltage other than the power supply voltage VDD is provided may be recognized.

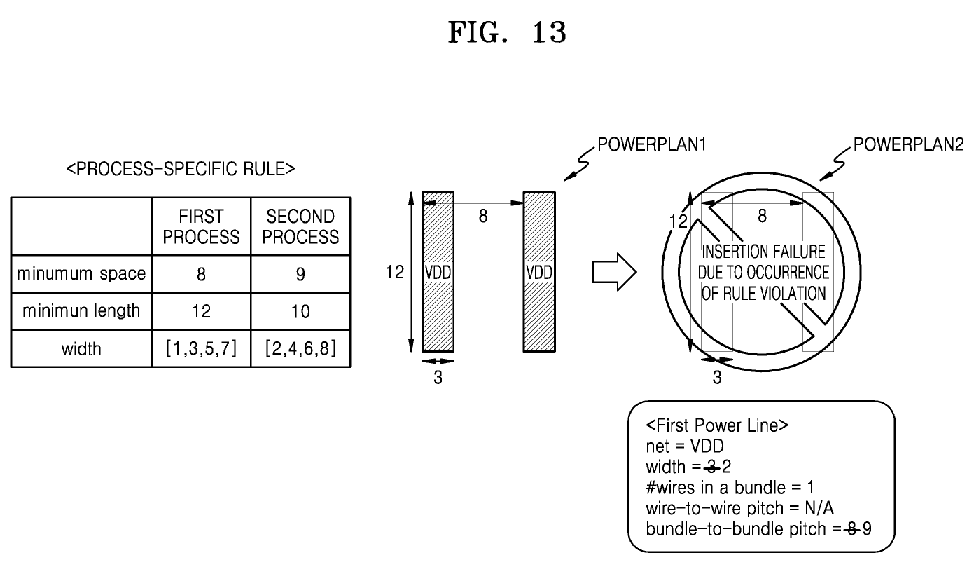

FIG. 13 illustrates a method of designing an IC, according to an embodiment, and more particularly, illustrates an example of operation S240 of FIG. 3.

Referring to FIG. 13, in an operation (e.g., S240 of FIG. 3) of forming a new wiring pattern for a power line in the floorplan of a second process, a regular wiring pattern recognized from a first power plan POWERPLAN1 of a first process may be changed to satisfy the rule of a second process, based on the rule of the second process, which is included in second process information. The rule of the second process may include at least one of the minimum pitch (minimum spacing) between bundles in which a regular wiring pattern is repeated, the minimum length of a power line, and possible widths of the power line.

For example, in the rule of the first process, the minimum pitch (minimum spacing) between bundles in which a regular wiring pattern is repeated may be 8 nm, the minimum length of the power line may be 12 nm, and possible widths of the power line may be 1, 3, 5, and 7 nm. However, in the rule of the second process, the minimum pitch (minimum spacing) between bundles in which a regular wiring pattern is repeated may be 9 nm, the minimum length of the power line may be 10 nm, and possible widths of the power line may be 2, 4, 6, and 8 nm.

When the information representing a regular wiring pattern of a first power line, which is recognized from the first power plan POWERPLAN1, e.g., 8 nm that is the pitch between bundles in which the regular wiring pattern is repeated, 12 nm that is the length of the first power line, and 3 nm that is the width of the first power line, is applied to a second power plan POWERPLAN2 as it is, the rule of the second process may be violated. Therefore, the regular wiring pattern of the first power line recognized from the first power plan POWERPLAN1 cannot be inserted into the second power plan POWERPLAN2 as it is. In an embodiment, after the width of the first power line is corrected to 2 nm and the pitch between bundles in which a regular wiring pattern is repeated is corrected to 9 nm to satisfy the rule of the second process, based on information representing the regular wiring pattern of the first power line, which is recognized from the first power plan POWERPLAN1, the first power line and a second power line may be inserted into the second power plan POWERPLAN2 based on the corrected information.

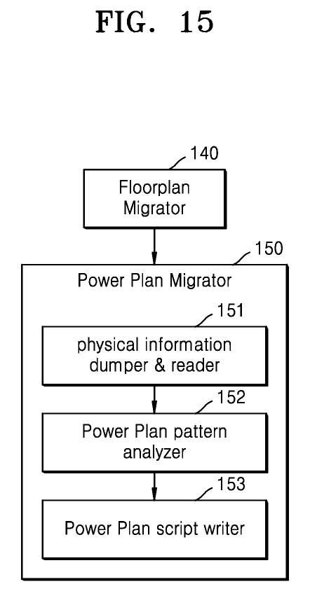

FIG. 14 is a block diagram illustrating a computing system 130 including a memory storing software instructions 134_1 for an integrated circuit design, according to an embodiment. FIG. 15 is a block diagram illustrating an example of the software instructions 134_1 stored in the memory of FIG. 14.

Referring to FIG. 14, a method of designing an IC, e.g., at least some of operations of the flowchart described above, according to embodiments, may be performed by the computing system (or computer) 130.

The computing system 130 may be a stationary computing system, such as a desktop computer, a workstation, or a server, or a portable computing system, such as a laptop computer. As shown in FIG. 14, the computing system 130 may include a processor 131, input/output devices 132, a network interface 133, random access memory (RAM) 134, read-only memory (ROM) 135, and a storage device 136. The processor 131, the input/output devices 132, the network interface 133, the RAM 134, the ROM 135, and the storage device 136 may be connected to a bus 137 and communicate with each other via the bus 137.

The processor 131 may be referred to as a processing unit and may include at least one core, e.g., a micro-processor, an application processor (AP), a digital signal processor (DSP), and a graphics processing unit (GPU), capable of executing an arbitrary instruction set (e.g., Intel architecture (IA)-32, 64-bit extended IA-32, x86-64, PowerPC, Sparc, million instructions per second (MIPS), advanced reduced instruction set computer (RISC) machine (ARM), IA-64, or the like). For example, the processor 131 may access the memory, i.e., the RAM 134 or the ROM 135, via the bus 137 and execute instructions stored in the RAM 134 or the ROM 135.

The RAM 134 may store the software instructions 134_1 for a method of designing an IC, according to an embodiment, or at least a portion of the software instructions 134_1, and the software instructions 134_1 may cause the processor 131 to perform the method of designing an IC, e.g., at least some of the operations of FIG. 1.

That is, the software instructions 134_1 may include a plurality of instructions executable by the processor 131, and the plurality of instructions included in the software instructions 134_1 may cause the processor 131 to perform, for example, at least some of operations included in the flowcharts described above.

Referring to FIGS. 14 and 15, the software instructions 134_1 may include a floorplan migrator 140 and a power plan migrator 150. For example, when the floorplan migrator 140 is executed by the processor 131, the floorplan operation S10 described with reference to FIG. 1 may be performed, and when the power plan migrator 150 is executed by the processor 131, the power plan operation S20 described with reference to FIG. 1 may be performed.

The power plan migrator 150 may include a physical information dumper and reader 151, a power plan pattern analyzer 152, and a power plan script writer 153. When the physical information dumper and reader 151 is executed by the processor 131, operations S210 and S220 of FIG. 3 may be performed, and first process information, first floorplan information, first power plan information, second process information, and second floorplan information extracted according to a performing result may be stored in a database 136_1. When the power plan pattern analyzer 152 is executed by the processor 131, operation S230 of FIG. 3 of recognizing a regular wiring pattern of a power line from the power plan of a first process may be performed. In addition, when the power plan script writer 153 is executed by the processor 131, operations S240 and S250 of forming a new wiring pattern for a power line in the floorplan of a second process and generating second power plan information including the new wiring pattern (i.e., into which the new wiring pattern is inserted) may be performed.

Referring to FIG. 14, the storage device 136 may not lose stored data even when power supplied to the computing system 130 is cut off. For example, the storage device 136 may include a non-volatile memory device and include a storage medium, such as a magnetic tape, an optical disc, or a magnetic disc. In addition, the storage device 136 may be detached from the computing system 130. The storage device 136 may store the software instructions 134_1 according to an embodiment, and before the software instructions 134_1 is executed by the processor 131, the software instructions 134_1 or at least a portion thereof may be loaded from the storage device 136 to the RAM 134. Alternatively, the storage device 136 may store a file created using a program language, and the software instructions 134_1 generated by a compiler from the file or at least a portion of the software instructions 134_1 may be loaded onto the RAM 134. In addition, as shown in FIG. 14, the storage device 136 may store the database 136_1, and the database 136_1 may include information required to design an IC, e.g., information representing designed blocks, a cell library, a design rule, and/or the like.

The storage device 136 may store data to be processed by the processor 131 or data processed by the processor 131. That is, the processor 131 may generate data by processing the data stored in the storage device 136 and store the generated data in the storage device 136, according to the software instructions 134_1. For example, the storage device 136 may store RTL data, netlist data, and/or layout data.

The input/output devices 132 may include an input device, such as a keyboard or a pointing device, and an output device, such as a display device or a printer. For example, a user may trigger execution of the software instructions 134_1 by the processor 131, input data, and check the layout data of FIG. 1 via the input/output devices 132. In addition, the power plan of the second process, which is newly designed through the power plan of the first process, may be checked.

The network interface 133 may provide access to a network outside the computing system 130. For example, the network may include a plurality of computing systems and communication links, and the communication links may include wired links, optical links, wireless links, or other arbitrary types of links.

While aspects of embodiments have been particularly shown and described, it will be understood that various changes in form and details may be made therein without departing from the spirit and scope of the following claims.

What is claimed is:

1. A method, performed by a computing system, of designing an integrated circuit, the method comprising:
extracting first process information, first floorplan information, and first power plan information from a power plan of a first process;
extracting second process information and second floorplan information from a floorplan of a second process;
recognizing a regular wiring pattern of a power line from the power plan of the first process based on the first power plan information;
forming a new wiring pattern of the power line according to the second process information and the second floorplan information; and
generating second power plan information comprising the new wiring pattern.

2. The method of claim 1, wherein the second process information represents any one or any combination of a line width of a process, a height of a placed standard cell, a number of wiring layers, and a spacing between tracks of a wiring layer.

3. The method of claim 1, wherein the first floorplan information comprises any one or any combination of shape and coordinate information of a space of a circuit function block, information representing input/output ports connected to input/output channels, information representing a placed macro cell, and information representing a blockage space in which neither a standard cell nor a wiring are placed.

4. The method of claim 1, wherein the second power plan information represents any one or any combination of a layer-specific width of a power line or a power via, coordinates of a layer-specific start point and end point of the power line or the power via, a layer-specific length of the power line or the power via, and layer-specific name information of the power line or the power via.

5. The method of claim 1, wherein the recognizing of the regular wiring pattern comprises:
dividing a floorplan of the first process into a plurality of areas based on the first floorplan information and the first power plan information, and
recognizing the regular wiring pattern of the power line formed in an area among the plurality of areas.

6. The method of claim 1, wherein the recognizing of the regular wiring pattern comprises:
recognizing a bundle in which the regular wiring pattern is repeated;
recognizing a number of first power lines, a width of the first power lines, and a pitch between the first power lines in the bundle; and
recognizing a number of second power lines, a width of the second power lines, and a pitch between the second power lines in the bundle.

7. The method of claim 1, wherein the forming of the new wiring pattern according to the second process information and the second floorplan information comprises changing the regular wiring pattern to satisfy a rule of the second process, wherein the rule of the second process is included in the second process information.

8. The method of claim 7, wherein the rule of the second process represents any one or any combination of a minimum pitch between bundles in which the regular wiring pattern is repeated, a minimum length of the power line, and a width of the power line have.

9. The method of claim 1, further comprising placing standard cells, routing the standard cells, and generating layout data based on the second power plan information.

10. A method, performed by a computing system, of designing an integrated circuit, the method comprising:
dividing an initial floorplan into a plurality of areas based on initial floorplan information;
recognizing a regular wiring pattern of a power line formed in an area among the plurality of areas based on initial power plan information;
forming a new wiring pattern of the power line by changing, according to new process information and new floorplan information, the regular wiring pattern to satisfy a rule of a new process; and
generating new power plan information comprising the new wiring pattern.

11. The method of claim 10, wherein the new process information represents any one or any combination of a line width of a process, a height of a placed standard cell, a number of wiring layers, and a spacing between tracks of a wiring layer.

12. The method of claim 10, wherein each of the initial floorplan information and the new floorplan information comprises any one or any combination of shape and coordinate information of a space of a circuit function block, information representing input/output ports connected to input/output channels, information representing a placed macro cell, and information representing a blockage space in which neither the standard cell nor a wiring are placed.

13. The method of claim 10, wherein the new power plan information represents any one or any combination of a layer-specific width of a power line or a power via, coordinates of a layer-specific start point and end point of the power line or the power via, a layer-specific length of the power line or the power via, and layer-specific name information of the power line or the power via.

14. The method of claim 10, wherein the recognizing of the regular wiring pattern of the power line formed in the area comprises:
recognizing a bundle in which the regular wiring pattern is repeated;
recognizing a number of first power lines, a width of the first power lines, and a pitch between the first power lines in the bundle; and
recognizing a number of second power lines, a width of the second power lines, and a pitch between the second power lines in the bundle.

15. The method of claim 10, wherein the rule of the new process represents any one or any combination of values which a minimum pitch between bundles in which the regular wiring pattern is repeated, a minimum length of the power line, and a width of the power line have.

16. A computing system comprising:
a memory in which instructions are stored; and
a processor,
wherein the instructions, when executed by the processor, are configured to control the computing system to:
extract first process information, first floorplan information, and first power plan information from a power plan of a first process,
extract second process information and second floorplan information from a floorplan of a second process,
recognize a regular wiring pattern of a power line from the power plan of the first process based on the first power plan information,
form a new wiring pattern of the power line according to the second process information and the second floorplan information, and
generate second power plan information comprising the new wiring pattern.

17. The computing system of claim 16, wherein the instructions, when executed by the processor, are further configured to control the computing system to divide a floorplan of the first process into a plurality of areas based on the first floorplan information and the first power plan information, and recognize the regular wiring pattern of the power line formed in an area among the plurality of areas.

18. The computing system of claim 16, wherein the instructions, when executed by the processor, are further configured to control the computing system to recognize a bundle in which the regular wiring pattern is repeated, recognize a number of first power lines, a width of the first power lines, and a pitch between the first power lines in the bundle, and recognize a number of second power lines, a width of the second power lines, and a pitch between the second power lines in the bundle.

19. The computing system of claim 16, wherein the instructions, when executed by the processor, are further configured to control the computing system to change the regular wiring pattern to satisfy a rule of the second process, based on the rule of the second process, which is included in the second process information.

20. The computing system of claim 19, wherein the rule of the second process represents any one or any combination of values which a minimum pitch between bundles in which the regular wiring pattern is repeated, a minimum length of the power line, and a width of the power line have.
